(19) United States
(12) Patent Application Publication
(10) Pub. No.: US 2016/0250909 A1
(43) Pub. Date: Sep. 1, 2016

(54) AIR NOZZLE

(71) Applicant: DR. SCHNEIDER KUNSTSTOFFWERKE GMBH, Kronach (DE)

(72) Inventor: Johannes Schneider, Kueps (DE)

(21) Appl. No.: 15/032,288

(22) PCT Filed: Oct. 20, 2014
(86) PCT No.: PCT/EP2014/072443

§ 371 Date: Apr. 26, 2016

(30) Foreign Application Priority Data
Oct. 30, 2013 (DE) 10 2013 111 982.4
Feb. 4, 2014 (DE) 10 2014 101 315.8

(51) Int. Cl. B60H 1/34

(52) U.S. Cl. CPC B60H 1/3421

(57) ABSTRACT

An air vent includes a housing, which can be inserted into a wall opening or can be mounted behind a wall opening. An assembly for guiding and/or deflecting and/or stopping the supplied air flow is attached in the housing and comprises two separate louver blocks, which are offset from each other by an angle and/or arranged one behind the other. Each louver block includes a plurality of louvers coupled to each other.

The present invention relates an air vent with the features of claim 1.

Air vents for use in motor vehicles are sufficiently known. Air vents of that kind usually comprise separate slat blocks, which are angled relative to one another and by means of which the air flow entering the air vent is to be controlled and aligned in the orientation thereof. In that regard a slat block is arranged so that it bounds the air vent towards the interior space of the motor vehicle.

An air nozzle with slats with at least one setting element, which is operable by way of a drive, for regulating the air flow, particularly for a ventilating system of a motor vehicle, is known from DE 10 2004 046 059. The setting element comprises a plurality of slats. At least one further setting element is actuable by way of a drive of the setting element.

An air nozzle provided with at least one guide surface producing a spin is known from DE 10 2007 061 576 A1 . In addition, a screen with a plurality of spin generators arranged adjacent to one another is provided.

An air vent device for the interior space of a motor vehicle is known from DE 41 36 822 A1. The air vent device comprises a ventilation nozzle, which is equipped with air guide elements, and a screen, which is associated therewith in downstream direction, with slot-like outlet openings separated by way of webs. The air guide elements are arranged at the ventilation nozzle, which is movable about an axis of rotation, and this nozzle is no connected in terms of drive with a step transmission of an actuating device that the air guide elements are aligned with adjacent webs of the screen in every selected outflow direction.

A device for the air-conditioning of an interior space, particularly a vehicle interior space, with an air-conditioning unit with a conditioned air guide and with an air heating unit (3) with a hot air guide is known from DE 100 36 776 A1. The conditioned air guide and the hot air guide are connected with the interior space. The conditioned air guide and the hot air guide are led together by way of a mouthpiece in the form of a double nozzle, which has an inner pipe and a concentric outer pipe and which is constructed as, in particular, a double nozzle according to the jet nozzle principle and/or according to the spin flow principle.

An air vent with a nozzle housing, an air inlet disposed in axial direction with respect to the nozzle housing and an air outlet opening substantially opposite the air inlet opening is known from DE 10 2007 019 602 B3. A conical air guide element is present, wherein the air guide element is arranged with a longitudinal axis in axial direction with respect to the nozzle housing and the air guide element is arranged with its pointed side towards the air outlet opening. The air guide element has a continuous opening in its longitudinal axis. Moreover, a manipulator intended for reception of the continuous opening of the air guide element is provided. The nozzle housing and the air guide element serve for producing a Coanda effect.

A ventilating device with a housing having an inflow region, into which an air channel opens, and an outflow region, in which an air guide device and a throttle device are provided, is known from DE 197 39 652 A1. The air guide device and the throttle device are adjustable by may of control elements. The throttle device comprises two throttle elements movable relative to one another. It is possible through movement of the throttle elements relative to one another to vary the outlet cross-section without changing the flow direction of the issuing air.

US 2010/0304655 A1 discloses an air vent with V-shaped opposite regions protruding into the air outlet region.

JP 2009 160981 A similarly discloses an air vent with V-shaped regions protruding into an air outlet region of the air vent.

It is disadvantageous with the known prior art that the known air vents, due to the slat blocks let into the front side, have a certain dimensioning and size.

The present invention therefore has the object of outlining an air vent, the air guide and air deflecting elements of which are arranged in the housing and barely visible from the outside and which is of elongate and extended form. In a further advantageous form of the invention an element shall be fixedly arranged in the air outlet opening and at the same time form part of the air outlet opening.

This object is fulfilled by way of the features of claim 1.

Advantageous embodiments of the invention are illustrated in the subclaims, in the further description and in actual examples.

An air vent according to the invention has at least one opening for supplying an air flow and at least one opening for discharging the supplied air flow. At least one arrangement for guidance, deflection and/or preventing the supplied air flow is present, wherein the air flow can be supplied to the air vent from an air supply shaft or from an air supply duct in heating, ventilating or air-conditioning installations, particularly for passenger compartments in motor vehicles and wherein the air vent consists of a housing insertable into a wall passage or mountable behind such. At least one element is arranged in the opening for discharge of the air flow and the arrangement for guiding, deflecting and/or preventing the supplied air flow is mounted in the interior of the housing behind the at least one element. In addition, a housing upper side and a housing lower side extend in V-shape in the region of the opening in that inner surfaces in the region of the opening rise in the direction of an outer edge of the opening and then drop away outwardly. A respective stationary slat is arranged above and below equidistantly from the at least one element.

The orientation of the air flow issuing from the air outlet opening of the air vent is produced by way of air guide elements in the interior of or within the housing of the air vent. By virtue of this form of deflection or orientation of the air flow, preferably within the housing, the air outlet opening of the air vent can be freely designed. The outflowing air is additionally Oriented by the V-shaped termination of the housing upper side and the housing lower side in the region of the opening.

In an advantageous embodiment of the invention according to claim 2 provision is made for the at least one element to be rigidly arranged in the opening for discharge of the air flow and to be almost flush with two mutually opposite surfaces, which enclose the opening for discharge of the air flow, of the housing. On the one hand this makes it possible to design the element to be flat, the housing to be elongate and the housing walls to be thin and yet to impart the requisite stiffness and stability to the housing.

In an advantageous embodiment of the invention according to claim 3 it is provided that the at least one element is arranged to be displaceable in horizontal direction in the opening for discharge of the air flow and is virtually flush with the two mutually opposite side surfaces, which laterally enclose the opening, of the housing. The displaceable element is responsible for controlling the air flow in horizontal direction, i.e. to the right or left. An adjusting element is required for closing the air outflow opening upwardly or downwardly, for example a vertically arranged control wheel at the side, so that the air flow can flow out in oriented manner from either the upper or the lower opening which is left. The issuing air flow, notwithstanding the stationary element, can be varied and directionally guided by an additional shaping of the upper and lower housing edges, for example in slat form.

In an advantageous embodiment of the invention according to claim 4 it is provided that the arrangement consists of at least two separate elements, which are offset relative to one another by an angle and/or arranged one behind the other, so that the air flow issuing from the opening for discharge of the air flow is settable or deflectable in its flow direction or can be almost completely prevented, wherein the elements consist of at least one slat or slat block, wherein the slat block comprises a plurality of intercoupled slats and wherein each of the intercoupled slats of a slat block is so mounted in the slat block that the slats of the slat block are pivotable in common about an axis. Through the arrangement consisting of at least two separate elements arranged to be offset relative to one another or one behind the other it is possible for the air flow in the housing to be oriented and/or influenced in its flow intensity, i.e. reduced.

In an advantageous embodiment of the invention according to claim 5 it is provided that the V-shaped course in the region of the opening extends over the entire front side of the housing.

In an advantageous embodiment of the invention according to claim 6 it is provided that the opening simulates the surface of a circularly cylindrical section concave towards the interior space of the housing.

In an advantageous embodiment of the invention according to claim 7 it is provided that the at least one element is a slat, a circular cylinder flattened at one side or a block.

In an advantageous embodiment of the invention according to claim 8 it is provided that the respective stationary slat is arranged to be recessed in the housing.

In an advantageous embodiment of the invention according to claim 9 it is provided that the inner surfaces of the housing upper side and the housing lower side in the region of the at least one element arranged in the opening at least in part take up the form of the at least one element. Through this shaping of the inner surfaces, influencing of the exiting air flow, which can be influenced in its outflow direction by this shaping, is produced.

It is particularly advantageous in the case of the embodiment of an air vent with a round housing that the auxiliary channels or bypasses responsible for air deflection upwardly or downwardly are also utilised for spot ventilation (straight) so that the permissible pressure loss value in the ventilating system is not exceeded. The two oppositely directed air flows, from above or from below, are mutually cancelling, i.e. the overall air flow is not diffuse, but remains concentrated.

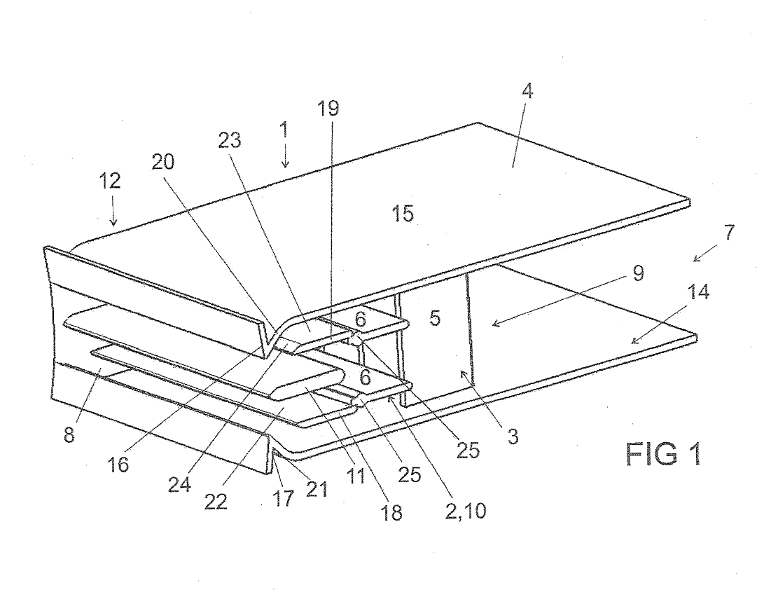

The invention is described in the following by way of actual embodiments on the basis of the figures FIG. 1 to FIG. 19.

This description on the basis of the actual embodiments does not represent a limitation of the invention to any one of these actual embodiments. Each concrete embodiment shows the invention by way of a form of embodiment of an air vent for a motor vehicle.

The same reference numerals are assigned to the same elements in the figures and in the description of the figures. This serves for improved clarity and ease of comprehension of the invention.

In the drawings:

FIG. 1 shows an air vent in a perspective sectional illustration;

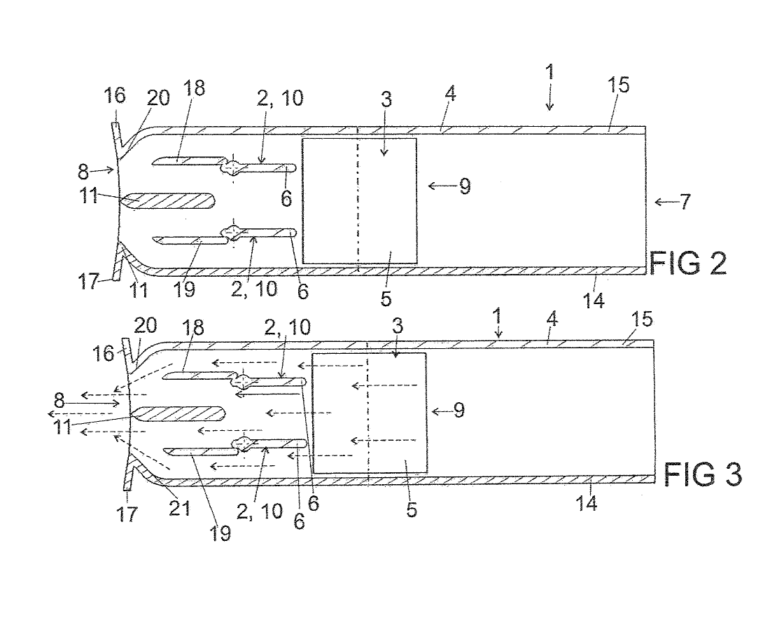

FIG. 2 shows a longitudinal section through an air vent;

FIG. 3 shows a longitudinal section through an air vent with a schematically illustrated air flow;

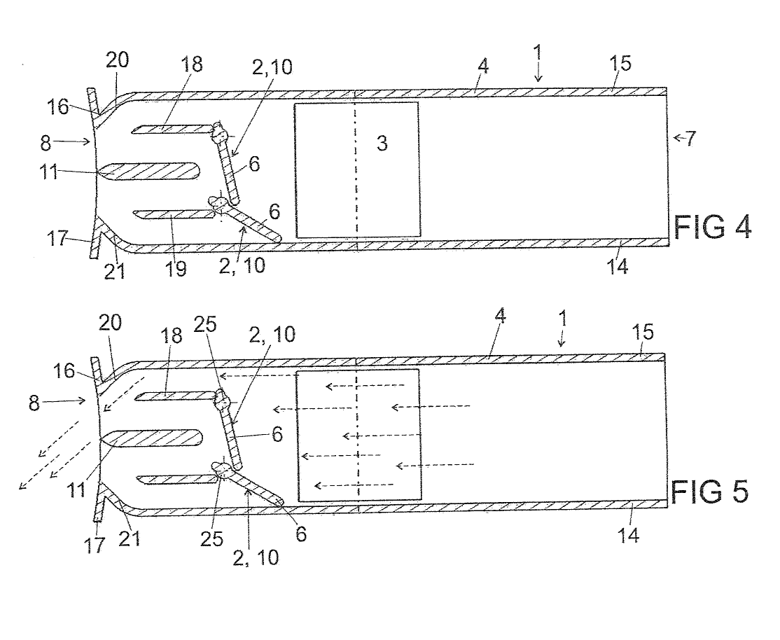

FIG. 4 shows a longitudinal section through an air vent;

FIG. 5 shows a longitudinal section through an air vent with a schematically illustrated air flow;

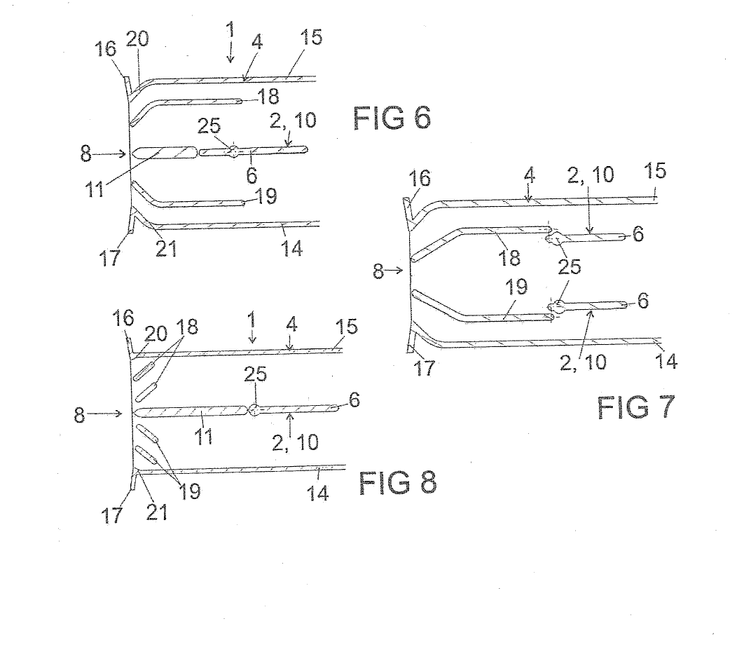

FIGS. 6 to 8 show sections through schematically illustrated air vents;

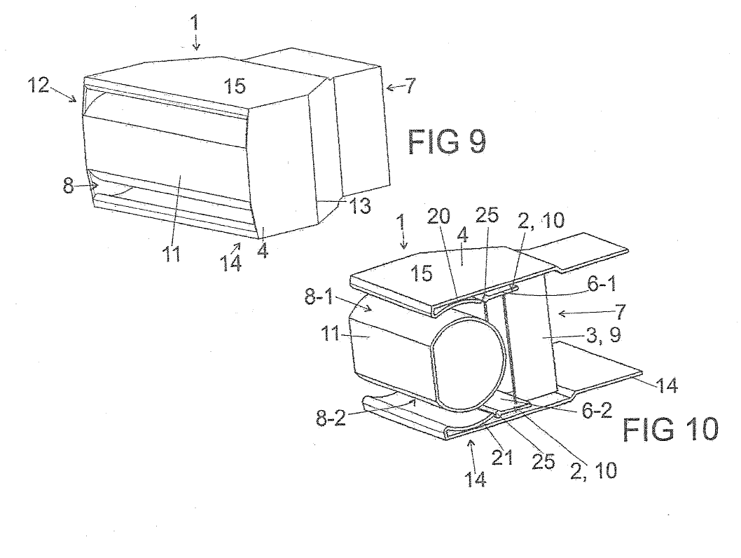

FIG. 9 shows a perspective illustration of an air vent;

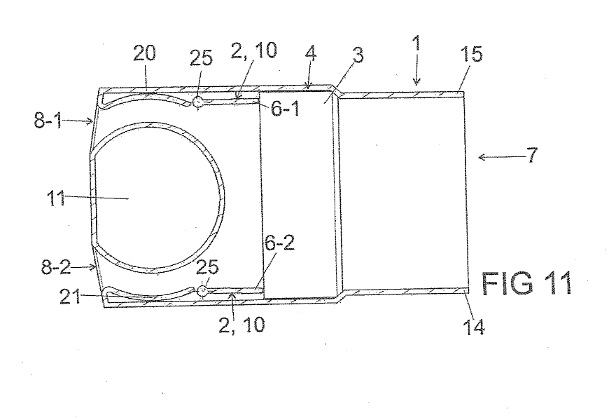

FIG. 10 shows an air vent in a perspective sectional illustration;

FIG. 11 shows a longitudinal section through an air vent;

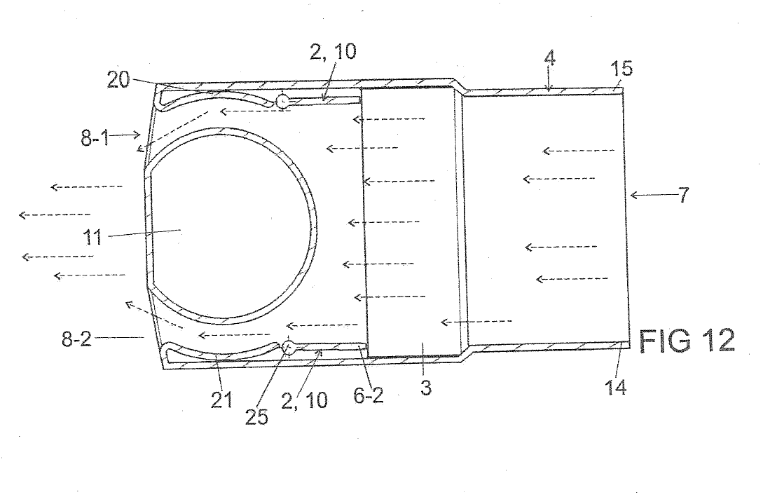

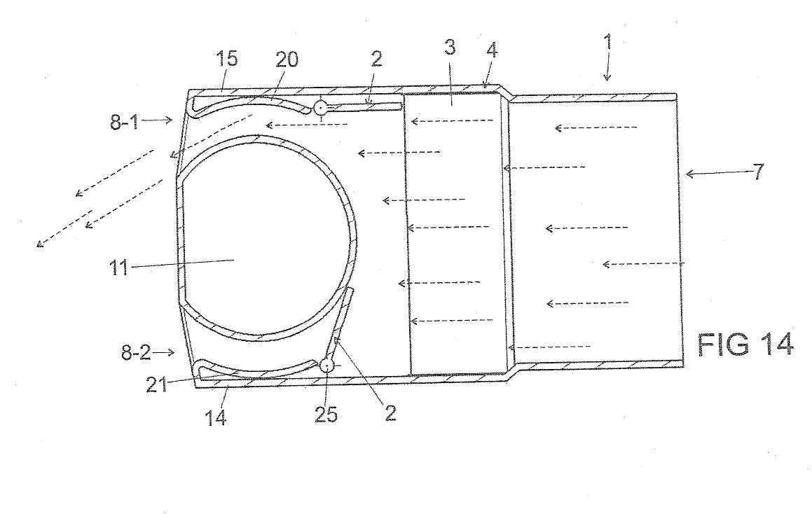

FIGS. 12 and 14 each show a longitudinal section through an air vent with a schematically illustrated air flow;

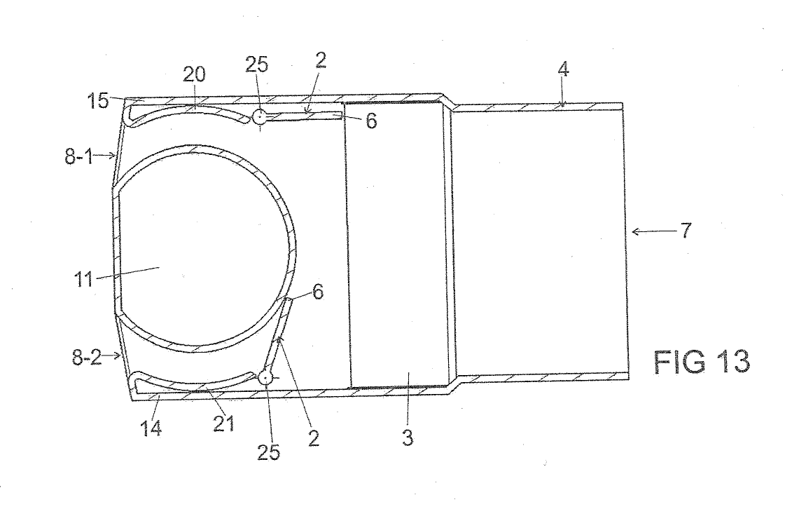

FIG. 13 shows a longitudinal section through an air vent;

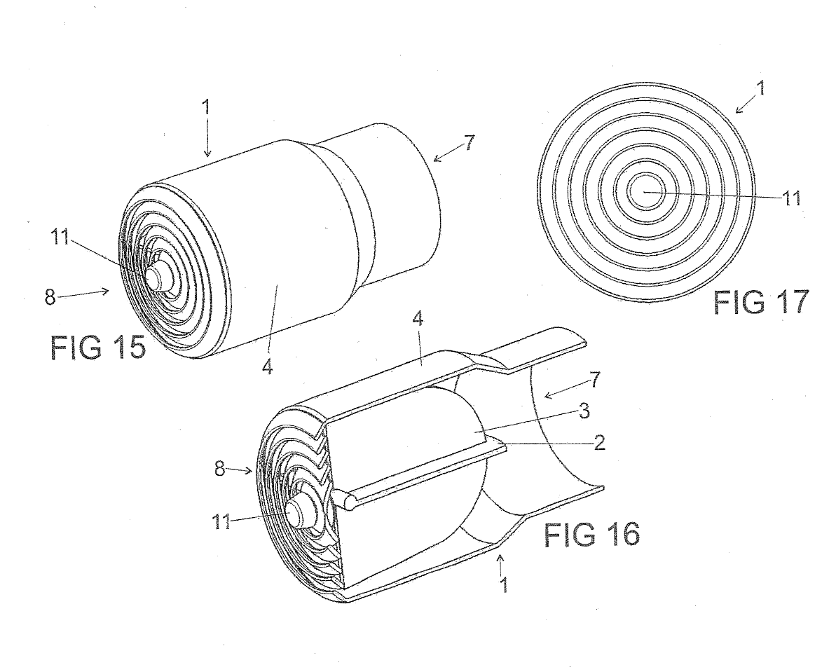

FIG. 15 shows a perspective illustration of an air vent;

FIG. 16 shows an air vent in a perspective sectional illustration;

FIG. 17 shows a front view of an air vent;

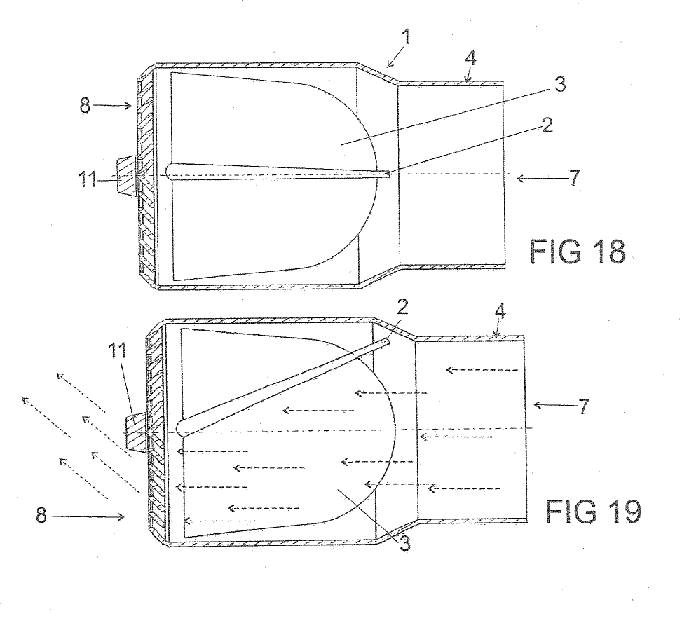

FIG. 18 shows a longitudinal section through an air vent; and

FIG. 19 shows a longitudinal section through an air vent with a schematically illustrated air flow.

An air vent is illustrated in FIG. 1 in a perspective sectional illustration. The air vent 1 consists of a housing 4 with the housing side surface 12 illustrated in FIG. 1, the housing upper side 15 and the housing lower side 14. Due to the sectional illustration the housing side surface 13 of the housing 4 is not illustrated. The housing 4 has an opening 7, by way of which an air flow can be supplied, as well as at least one opening 8, from which the supplied air flow is discharged from the air vent 1. Provided in the housing 4 of the air vent 1 is an arrangement 2, 3 serving the purpose of aligning the air flow, which has entered the air vent 1, in its orientation. In the embodiment according to FIG. 1 the arrangement is provided by slats 5, 6 which, in an advantageous embodiment, are combined to form slat blocks 9, 10 or in each instance at least one slat block. The slats 5, 6 of a slat block 9, 10 can be pivoted individually or in common in the slat block 9, 10. An element 11 which in FIG. 1 is designed in the form of a slat is arranged in the air vent opening 8. The element 11 is preferably arranged centrally in the opening 8 and extends over the entire width of the opening 8. Two stationary and similarly non-pivotable slats 18, 19 are arranged above and below the element 11. These slats 18, 19 are coupled to the side walls 12, 13 of the housing 4, the slats 18, 19 being recessed in the housing 4 relative to the element 11. The element 11 is virtually flush at the front side with the front of the air vent 1. The slats 6 of the arrangement 2 are arranged at the two stationary slats 18, 19 to be pivotable about the longitudinal axis of the slats 18, 19. The slats 5 form a slat block 9 and the slats 6 form a slat block 10.

The slats 18, 19 are the some in their shape and dimensioning and are designed in the form of a straight prism, which in the region of the opening 8 defines a wedge-shaped region 24. The slats 18, 19 preferably have a smooth-surfaced side 22, a prismatic upper side 23 and a front side forming the wedge region 24. The slats 18, 19 are arranged to face one another in the housing 4 by the two smooth-surfaced sides 22, which preferably have smoothly planar surfaces.

The front side of the housing 4 has a V-shaped course 16, 17. The upper housing side 15 and lower housing side 14 form inner surfaces 20, 21 in the region of the opening 8, which rise in the direction of the outer edge of the opening 8 and then drop away outwardly no that a characteristic V-shape, which forms an air flow separation edge, is defined. The air flow issuing from the opening 8 is directed and guided by the slope of the air separation edge.

A straight section through the air vent 1 of FIG. 1 is illustrated in FIG. 2. The section is taken longitudinally through the housing 4 of the air vent 1, which has a block-shaped form. The opening 7 for supply of an air flow is illustrated at the rear end of the housing 4 and the opening 8 for discharge of the air flow is illustrated at the front side. The element 11 is arranged in the form of a slat centrally in the middle and fixedly in the air outlet opening 8. The slats 18, 19 are positioned above and below. The slats 6 are articulated to the slats 18, 19 by way of a joint 25. The joint 25 is a rotary joint. The slat block 9, consisting of the slats 5, is arranged in the housing 4 behind the slat block 10. The air flow, which is guided through the air vent 1, is deflectable in its orientation in horizontal and/or vertical direction by means of the slats 5, 6. The slats 18, 19 and the element 11 in conjunction with the V-shaped course 16, 17 of the housing additionally influence the orientation of the air flow.

The air flow which is led through the air vent 1 in accordance with FIG. 2 is illustrated by dashed-line arrows in FIG. 3. It shows that the slats 5, 6 in their orientation illustrated in FIG. 3 do not influence the air flow. The deflection and orientation of the air flow takes place only through the co-operation of the slats 18, 19, the V-shaped course 16, 17 of the housing and the arrangement of the element 11.

The air flow flowing upwardly around the slat 18 is deflected downwardly by way of the slat 18 and the V-shaped course 16 of the housing and the air flow flowing downwardly around the slat 19 is deflected upwardly by way of the slat 19 and the V-shaped course 17 of the housing; the air flow flowing around the element 11 exits—directed forwardly almost rectilinearly—the opening 8.

By contrast to the illustration in FIG. 2, in FIG. 4 the slats 6 are set no that an air flow entering by way of the opening 7 can exit only by way of the opening then still present above the slat 18.

In FIG. 5 the air flow, which is guided through the air vent 1 in accordance with FIG. 4, is illustrated by dashed-line arrows. The air flow entering by way of the opening 7 can run only above the slat 18 and thus issue in guided manner from the opening 8. This air flow is deflected downwardly by the slat 18 and the V-shaped course 16 of the housing.

A further embodiment and arrangement of the slats 18 and 19 in the housing 4 of the air vent 1 is illustrated in FIG. 6. The slats 18 and 19 are fixedly arranged in the housing 4 and are flush with the element 11, which is similarly fixedly arranged, almost planarly in the opening 8. The slat 18 extends parallel to the housing upper side 15 and the slat 19 extends parallel to the housing lower side 14. The slats 18, 19 in the front region follow the course of the inner surface 20, 21 closest to the slats 18, 19.

The slat 6 is arranged behind the element 11. The slat 6—there can also be several slats 6, forming a slat block 10, which in analogous manner is arranged behind the element 11—is again present. The slat 6 is, in an advantageous embodiment, connected with the element 11 or coupled thereto. The slat 6 has a joint 25 by which the slat 6 is pivotable about its longitudinal axis. The slat 6 is so selected in its dimensioning that the slat 6 in upwardly pivoted setting closes the housing 4 above the element 11 and the slat 6 in downwardly pivoted setting closes the housing 4 below the element 11; intermediate settings are possible.

A further embodiment and arrangement of the slats 18 and 19 in the housing 4 of the air vent 1 is illustrated in FIG. 7. In FIG. 7 the element 11 is eliminated and a slat 6 is articulated to each of the slats 18, 19 by way of a respective joint 25. The slats 6 are pivotable in common, in which case pivotation can take place in parallel or in opposite sense.

A further embodiment and arrangement of the slats 18 and 19 in the housing 4 of the air vent 1 is illustrated in FIG. 8. The element 11 is arranged centrally in the opening 8 of the air vent 1. Arranged above the element 11 in paired manner are two slats 18 and below the element 11 two slats 19 similarly in paired manner. The slats 18, 19 are relatively short and arranged at an acute angle with respect to the element 11. A joint 25, at which the slat 6 is arranged for varying and deflecting the air flow in the housing 4, is present behind the element 11.

A further air vent 1 is illustrated in FIG. 9. A stationary element 11, which in the embodiment according to FIG. 9 is in the form of a roller flattened at one side or a round cylinder flattened at one side, is arranged centrally in the opening 8. The element 11 is fixedly arranged in the air outlet opening 8.

In a particularly advantageous embodiment of the invention the element 11 is vertically displaceable and can be displaced between the housing upper side 15 and the housing lower side 14 of the housing 4 and then locked in a selected setting.

In the case of the central arrangement of the element 11 in the opening 8 of the housing 4 two openings 8-1, 8-2, by way of which an air flow can issue, are left in the opening 8. The housing 4 is, in principle, formed to be block-shaped, but has a taper in the direction of the air inlet opening 7.

A perspective section through the air vent 1 according to FIG. 9 is illustrated in FIG. 10. It shows that the element 11 has a roller-shaped design or a round cylindrical form with a flattened front. Moreover, the arrangements 2, 3, which can again be slats 5, 6-1, 6-2 or slat blocks 9, 10, are present and serve for deflecting the air flow. The inner surfaces 20, 21 of the housing upper side 15 and the housing lower side 14 adopt the radius of the cylinder of the element 11. The slats 6-1, 6-2 are coupled to joints 25 arranged at the ends of the inner surfaces 20, 21. In one setting the slats 6-1, 6-2 lie parallel to the housing upper side 15 and the housing lower side 14. If the upper slat 6-1 is pivoted downwardly, then the upper opening 8-1 is closed; if the lower slat 6-2 is pivoted upwardly, then the lower opening 8-2 is closed.

A longitudinal section through the air vent according to FIG. 9 is illustrated in FIG. 11. The two slats 6-1 and 6-2 are deflected to be parallel to the housing upper side 15 and to the housing lower side 14.

The air flow guided through the air vent 1 in accordance with FIG. 11 is illustrated in FIG. 12 by dashed-line arrows. The air flow exits by way of the openings 8-1 and 8-2 and runs almost linearly.

The air flow in the air vent 1 of FIG. 11 is illustrated in FIG. 13, but the lower slat 6-2 is pivoted upwardly and closes the opening 8-2.

The air flow which is guided through the air vent 1 in accordance with FIG. 12 is illustrated by dashed-line arrows in FIG. 14. The air flow issues merely by way of the upper opening 8-1. The air flow guided in the air vent 1 is thus influenced in its orientation, due to the form of the opening 8, in such a way that the alignment of the air flow when the opening 8-2 is closed by means of the slat 6-2 exits the opening 8-1 with a downward deflection.

A round air vent 1 is illustrated in FIG. 15. An element 11 is arranged in the air outlet opening 8. Concentrically arranged stationary slats surround this element 11. The housing 4 is formed as a cylinder with a taper towards the air inlet opening 7.

A section through a perspectively illustrated air vent according to FIG. 15 is illustrated in FIG. 16. The arrangements 2 and 3, by means of which the air flow can be influenced in its orientation, are illustrated. In an advantageous embodiment of the invention the arrangement 3 is a slat.

A plan view of an air vent 1 according to FIG. 15 is illustrated from the front in FIG. 17. The stationary element 11 and the slats concentrically surrounding the stationary element are illustrated.

A longitudinal section through the air vent 1 according to FIG. 15 is illustrated in FIG. 18. In particular, the arrangement 2, which can influence the air flow in its orientation in the horizontal plane in vertical deflection, is illustrated.

The air flow, which is influenced in the air vent 1 and orients itself with downward direction from the opening 8 for the air exit, is schematically illustrated in FIG. 9. This takes place in that the upper part of the opening 8 is almost closed by the arrangement 2.

### Reference Numeral List

1 air vent
2, 3 arrangement
4 housing
5 slat
6 slat
7 opening for entry of an air flow
8 opening for discharge of an air flow
9 slat block
10 slat block
11 element
12 housing side surface
13 housing side surface
14 housing lower side
15 housing upper side
16, 17 V-shaped course
18, 19 stationary slat
20, 21 inner surface
22 smooth-surfaced region of the slats
23 prismatic region of the slats
24 wedge-shaped region of the slats
25 joint

1-9. (canceled)

10. An air vent with at least one opening for the supply of an air flow and at least one opening for discharge of the supplied air flow, with an arrangement for guiding and/or deflecting and/or preventing the supplied air flow, wherein the air flow can be supplied to the air vent from an air supply shaft or from an air supply duct in heating, ventilating or air-conditioning installations, particularly for passenger compartments in motor vehicles, wherein the air vent includes a housing which is insertable into a wall passage or mountable behind such, wherein at least one element is arranged in the opening for discharge of the air flow and the arrangement for guiding and/or deflecting and/or preventing the supplied air flow is arranged in an interior of the housing behind the at least one element, wherein a housing upper side and a housing lower side terminate in V-shape in the region of the opening in that inner surfaces in the region of the opening rise in the direction of an outer edge of the opening and then fall away outwardly and two stationary slats are arranged above and below equidistantly from the at least one element.

11. The air vent according to claim 10, wherein the at least one element is rigidly arranged in the opening for discharge of the air flow and that the at least one element is virtually flush with two mutually opposite surfaces, which enclose the opening, of the housing.

12. The air vent according to claim 10, wherein the at least one element is arranged to be displaceable in horizontal direction in the opening for discharge of the air flow and that the at least one element is virtually flush with the two mutually opposite side surfaces, which laterally enclose the opening, of the housing.

13. The air vent according to claim 10, wherein the arrangement is formed from at least two separate elements offset relative to one another by an angle and/or arranged one behind the other so that the air flow issuing from the opening for discharge of the supplied air flow is settable or deflectable in its flow direction or capable of being almost completely prevented, wherein the elements consist of at least one slat or slat block, wherein a slat block comprises a plurality of intercoupled slats and wherein each of the intercoupled slats of a slat block is so mounted in the slat block that the slats of a slat block are pivotable in common about an axis.

14. The air vent according to claim 10, wherein the V-shaped course in the region of the opening extends over the entire front side of the housing.

15. The air vent according to claim 10, wherein the opening has the form of a circular-cylinder section concave towards the interior space of the housing.

16. The air vent according to claim 10, wherein the at least one element is a slat, a circular cylinder flattened at one side, or a block.

17. The air vent according to claim 10, wherein the two stationary slats are arranged to be slightly recessed in the housing.

18. The air vent according to claim 10, wherein the inner surfaces of the housing upper side and the housing lower side in the region of the at least one element arranged in the opening at least in part adopt the shape of the at least one element.
